(19) United States
(12) Patent Application Publication
(10) Pub. No.: US 2003/0200604 A1
(43) Pub. Date: Oct. 30, 2003

(54) Spa with ozone gas removal system

(75) Inventors: Casey Loyd, Pomona, CA (US); Pedro Vargas, Pomona, CA (US)

Correspondence Address: SHELDON & MAK, 9th Floor, 225 South Lake Avenue, Pasadena, CA, 91101, US

(73) Assignee: California Acrylic Industries

(21) Appl. No.: 10/135,244

(22) Filed: Apr. 30, 2002

(51) Int. Cl. A61H 33/06

(52) U.S. Cl. 4/541.5

(57) ABSTRACT

A water recreational combination has a water basin and a water recirculation system. The water recirculation system includes an ozone generator for injecting ozone into recirculated water. Piping within the water recirculation system includes an ejector for drawing air into recirculated water. The air input opening for the ejector is disposed within the interior portion of the water basin so as to draw off any accumulated ozone above the water level when the basin is covered.

### BACKGROUND OF THE INVENTION

Water recreation and water therapy devices, such as spas, hot tubs, recirculating bath tubs and the like have become very popular.

Some people, however, have expressed concern about the possibility of the build-up of microorganisms within the recirculating water. To address this perceived problem, a few manufacturers are now offering recirculation systems with ozone generators. The ozone generators inject small amounts of ozone into the recirculating water on a continuous basis. Such ozone has been shown to be effective in getting rid of nearly all of the microorganisms within the recirculation water.

There is a problem, however, with the use of such ozone generators. When the spa or other water recreational/therapy device is not in use, it is commonly recommended to cover the water basin but continue the recirculation of the water, including the injected ozone.

This, however, can tend to lead to a heightened concentration of ozone in the air pocket above the water within the basin and below the cover. Such increased ozone concentration can damage the cover, especially when the cover is manufactured from certain ozone-sensitive plastic materials.

Accordingly, there is a need for an invention which addresses this problem in the prior art.

### SUMMARY OF THE INVENTION

The invention satisfies this need. The invention is a water recreational combination comprising (a) a water basin capable of retaining a human being partially submerged below a level of water, the water basin comprising one or more side walls having an exterior surface, an interior surface and a top edge, the interior surface and the top edge defining an interior portion of the water basin, the water basin further comprising at least one drain opening and a plurality of water input openings, (b) a water pump having a suction side and a discharged side, (c) water circulation conduits connecting the at least one water basin drain opening to the suction side of the pump and connecting the discharge side of the pump to the plurality of water input openings in the water basin, (d) an ozone generator for generating ozone and discharging that ozone into the water circulation conduits, (e) an ejector disposed between the discharge side of the pump and the water inlet openings, the ejector being capable of drawing air into a water stream flowing from the pump to the water inlet openings, and (f) an air input opening for providing air to the ejector, the air input opening being disposed within the interior portion of the water basin.

When the water recreational combination is not in use and is covered with a water basin cover, any increased concentration of ozone between the top of the water and the underside of the cover can be drawn off by operating the recirculation system, whereby the ejector draws off the ozone concentrated air above the water level and ejects that air back into the water within the water basin.

### DESCRIPTION OF THE DRAWINGS

These and other features, aspects and advantages of the present invention will become better understood with reference to the following description, appended claims and accompanying drawings where:

FIG. 1 is a top view of a water recreational combination having features of the invention; and

FIG. 2 is a diagrammatic cross-sectional side view of a water recreational combination having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a water recreational combination 10 and a method for operating that combination 10 to reduce an elevated concentration of ozone in the air immediately above the water level 11 in the combination 10, when the combination 10 is not in use by a human being. As illustrated in the drawings, the invention comprises a water basin 12 capable of retaining a human being partially submerged below a quantity of water 14 within the water basin 12. The water basin 12 comprises one or more side walls 16 having an exterior surface 18, an interior surface 20 and a top edge 22. The interior surface 20 and the top edge 22 define an interior portion 24 of the water basin 12. The water basin 12 further comprises at least one drain opening 26 and a plurality of water input openings 28.

Typically, the water inlet openings 28 comprise water ejection jets 29.

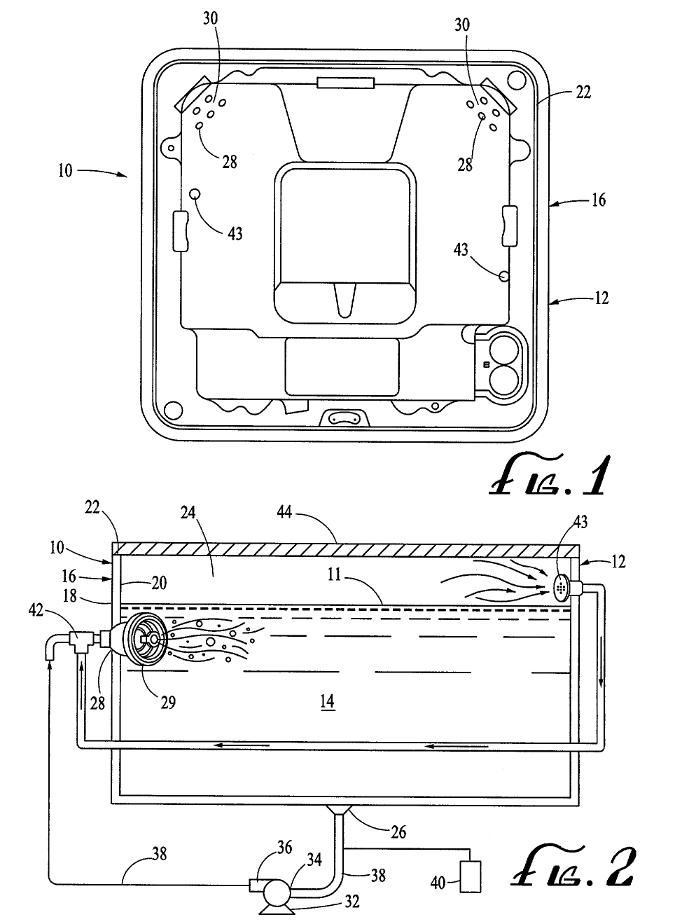

In the embodiment illustrated in FIG. 1, the water basin 12 comprises several seating areas 30 for seating a human user within the water basin 12. Typically, a portion of the plurality of water inlet openings 28 are located at each of the several seating areas 30.

The combination 10 further comprises a water circulation system including a water pump 32 having a suction side 34 and a discharge side 36, and water circulation conduits 38 connecting the water basin drain opening 26 to the suction side 34 of the pump 32, and connecting the discharge side 36 of the pump 32 to the plurality of water input openings 28 in the water basin 12.

The combination 10 further comprises an ozone generator 40 for generating ozone and discharging that ozone into the water circulation conduits 38.

The combination 10 further comprises at least one ejector 42 disposed between the discharge side 36 of the pump 32 and the water inlet openings 28. The ejector 42 is capable of drawing air into a water stream flowing from the pump 32 to the water inlet openings 28.

In the invention, at least one of the air inlet openings 43 for providing air to the ejector 42 is disposed within the interior portion 24 of the water basin 12.

When the water recreational combination 10 is not in use by a human being, the combination 10 typically further comprises a water basin cover 44 disposed over the top edge 22 of the one or more side walls 16 so as to fully enclose the water basin 12. The water recreational combination 10 can be used in the following way.

During use by a human being, the water basin cover 44 is removed, the circulation pump 32 is in operating mode, as is the ozone generator 40. During such use, ozone injected into the water circulation conduits 38 acts to minimize the concentration of any microbes which might otherwise live within the water 14 in the water basin 12. Thereafter, when the water recreational combination 10 is no longer in use, the water basin cover 44 is disposed over the top edge 22 of the one or more side walls 16 of the water basin 12, so as to fully enclose the water basin 12. The ozone generator 40 is turned off, but the water pump 32 is left on. As the water pump 32 circulates water from the drain opening 26 of the water basin 12, through the ejector 42 and back into the water basin 12 via the plurality of water input openings 28, any increased ozone concentration in the air space 46 immediately above the water level 11 and below the water basin cover 44 is drawn off by the ejector 42 via the air input opening 43 and is placed back into the water 14 within the water basin 12.

Thus, it can be seen that the invention provides a simple and inexpensive way to minimize any excess concentration of ozone beneath a water basin cover enclosing the water basin—so as to preserve the life of the water basin cover.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A water recreational combination comprising:
(a) a water basin capable of retaining a human being partially submerged below a quantity of water, the water basin comprising one or more side walls having an exterior surface, an interior surface and a top edge, the interior surface and the top edge defining an interior portion of the water basin, the water basin further comprising at least one drain opening and a plurality of water input openings;
(b) a water pump having a suction side and a discharged side;
(c) water circulation conduits connecting the at least one water basin drain opening to the suction side of the pump and connecting the discharge side of the pump to the plurality of water input openings in the water basin;
(d) an ozone generator for generating ozone and discharging that ozone into the water circulation conduits;
(e) an ejector disposed between the discharge side of the pump and the water inlet openings, the ejector being capable of drawing air into a water stream flowing from the pump to the water inlet openings; and
(f) an air input opening for providing air to the ejector, the air input opening being disposed within the interior portion of the water basin.

2. The water recreational combination of claim 1 further comprising a water basin cover disposed over the top edge of the one or more sidewalls of the water basin so as to fully enclose the water basin.

3. A method of reducing the concentration of ozone in the air above a water recreational combination wherein the water recreational combination comprises:
(a) a water basin capable of retaining a human being partially submerged below a level of water, the water basin comprising one or more side walls having an exterior surface, an interior surface and a top edge, the interior surface and the top edge defining an interior portion of the water basin, the water basin further comprising at least one drain opening and a plurality of water input openings;
(b) water within the water basin, the water defining a water level;
(c) a water pump having a suction side and a discharged side;
(d) water circulation conduits connecting the at least one water basin drain opening to the suction side of the pump and connecting the discharge side of the pump to the plurality of water input openings in the water basin;
(e) an ozone generator for generating ozone and discharging that ozone into the water circulation conduits;
(f) an ejector disposed between the discharge side of the pump and the water inlet openings, the ejector being capable of drawing air into a water stream flowing from the pump to the water inlet openings;
(g) an air input opening for providing air to the ejector, the air input opening being disposed within the interior portion of the water basin; and
(h) a water basin cover disposed over the top edge of the one or more side walls of the basin so as to fully enclose the water basin;
the method comprising the step of circulating water from the drain opening in the water basin, through the water circulation conduits and back into the water basin via the water pump, whereby ozone-containing air disposed between the water level and the water basin cover is drawn into the water circulation conduits via the air input opening and the ejector.
